(19) United States
(12) Patent Application Publication
(10) Pub. No.: US 2026/0178298 A1
(43) Pub. Date: Jun. 25, 2026

(54) EVALUATION OF BLUEPRINTS USED TO MANAGE OPERATION OF DATA PROCESSING SYSTEMS

(71) Applicant: Dell Products L.P., Round Rock, TX (US)

(72) Inventors: CRAIG O'LEARY, Cork (IE); DEBORAH C. RUSSELL, Arvada, CO (US); MUZHAR S. KHOKHAR, Shrewsbury, MA (US)

(21) Appl. No.: 18/987,089

(22) Filed: Dec. 19, 2024

(51) Int. Cl. G06F 8/60; G06F 8/70

(52) U.S. Cl. CPC G06F 8/60; G06F 8/70

(57) ABSTRACT

Methods and systems for managing operation of a deployment of data processing systems are disclosed. Operation of the deployment may be updated using a blueprint that may define a predetermined state of the data processing systems. The blueprint and corresponding criteria may be provided. Based on the criteria, and using a trained machine learning model and a knowledge base, changes to the blueprint may be identified that may be used to obtain a finalized blueprint. While operating based on the finalized blueprint, data processing systems may be monitored to identify whether the operation meets the criteria. Finalized blueprints may be iteratively updated to update the knowledge base and operation of data processing systems using the finalized blueprints.

### FIELD

Embodiments disclosed herein relate generally to managing operation of a deployment comprising data processing systems. More particularly, embodiments disclosed herein relate to managing operation of the deployment using a blueprint.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a deployment comprising data processing systems. To manage operation of the deployments, blueprints may be used to update operation of the data processing systems.

A blueprint of the blueprints may be evaluated, using a trained machine learning model and a knowledge base, to identify at least one potential change to the blueprint with respect to criteria that may indicate operational (e.g., performance) expectations for any data processing systems that are conformed to the blueprint. The knowledge base may provide information relevant to optimized operation (e.g., efficiency, performance, compatibility, etc.) of portions of the blueprint.

Operation of an updated data processing system may be monitored based on the criteria associated with the blueprint. In an instance of the monitoring where the operation does not meet the criteria, the blueprint may be iteratively updated, using the knowledge base and the trained machine learning model) to meet the criteria.

Based on the updated blueprint, a finalized blueprint may be stored in a finalized blueprint repository. Finalized blueprints from the finalized blueprint repository may be iteratively evaluated to enforce compliance of the finalized blueprints with the knowledge base.

Thus, embodiments disclosed herein may provide an improved method for managing operation of a deployment of data processing systems using a blueprint. By iteratively evaluating the blueprint using a knowledge base and a trained machine learning model, a finalized blueprint may be obtained that may be more likely to effectuate desired operation of the deployment when used.

In an embodiment, a method for managing operation of a deployment comprising data processing systems is provided. The method may include: (i) updating operation of a data processing system of the data processing systems using a blueprint to obtain an updated data processing system, the blueprint being from a finalized blueprint repository; (ii) monitoring operation of the updated data processing system based on criteria associated with the blueprint; (iii) in a first instance of the monitoring where the operation does not meet the criteria: (a) iteratively, using a trained machine learning model and a knowledge base, making changes to the blueprint until corresponding operation of the updated data processing system meets the criteria; (b) storing a finalized blueprint based on the iteratively made changes to the blueprint in the finalized blueprint repository; and (c) updating the knowledge base based on the iteratively made changes to the blueprint.

The finalized blueprint repository may store finalized blueprints that have been validated against the knowledge base.

The criteria may be obtained from the finalized blueprint repository.

The criteria and blueprint may be defined by a subject matter expert, and the criteria indicates performance expectations for any data processing systems that are conformed to the blueprint.

The data processing systems may host automation frameworks adapted to update operation of the data processing systems using blueprints.

The blueprints may include at least one selected from a group consisting of: (i) imperative statements; and (ii) declarative statements.

The method may also include: prior to updating the operation of the data processing system: (i) obtaining a prototype blueprint and a corresponding criteria; (ii) evaluating, using the trained machine learning model and the knowledge base, the prototype blueprint with respect to the criteria to identify at least one potential change to the prototype blueprint; (iii) obtaining the blueprint using the prototype blueprint and the at least one potential change; and (iv) storing the blueprint in the finalized blueprint repository.

The method may also include: iteratively evaluating finalized blueprints from the finalized blueprint repository based on corresponding criteria and information from the knowledge base to enforce compliance of the finalized blueprints with the knowledge base.

The finalized blueprints may be iteratively evaluated based on changes to the knowledge base.

The changes to the knowledge based may be identified based on corrections to blueprints made based on deviations between operation of some of the data processing systems based on the blueprints and a portion of the criteria corresponding to the blueprints.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

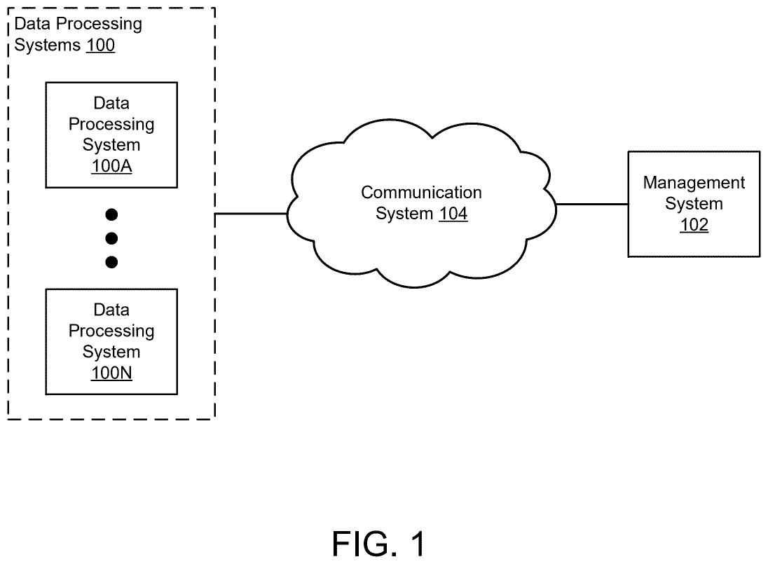

Turning to FIG. 1, a block diagram illustrating a system in accordance with an embodiment is shown. The system shown in FIG. 1 may provide any type and quantity of computer-implemented services (e.g., to user of the system and/or devices operably connected to the system).

The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1). Other types of computer-implemented services may be provided by the system shown in FIG. 1 without departing from embodiments disclosed herein.

To provide the computer-implemented services, the system may include data processing systems 100. Each data processing system (e.g., 100A, 100B, etc.) may provide similar and/or different computer-implemented services, and may provide the computer-implemented services independently and/or in cooperation with other data processing systems.

To provide at least a portion of the computer-implemented services, a data processing system (e.g., 100A) may be placed in a predetermined configuration. For example, to provide desired computer-implemented services (e.g., a database service, a banking service, etc.), data processing system 100A may need to host certain hardware and/or utilize certain software configurations, may need to refrain from utilizing second software that may conflict with the certain software configurations, and/or may be configured in any other manner.

To place data processing system 100A in the predetermined configuration, a blueprint may be used to update operation of data processing system 100A. The blueprint may define, for example, a structure for how resources (e.g., hardware and/or software) are provisioned for use by data processing system 100. For example, the blueprint may include a set of statements (e.g., infrastructure as code) that may be imperative statements (e.g., that define a sequence of tasks to execute to place the data processing system in the predetermined configuration) and/or declarative statements (e.g., that define a desired end state for operation of the data processing system).

The blueprint may be defined by an entity tasked with managing operation of the data processing system and/or a subject matter expert. For example, the entity may define the blueprint based on knowledge of resources (e.g., based on documentation) needed for operation of the data processing system and/or criteria relevant to the desired computer-implemented services.

However, a quality of computer-implemented services provided by the data processing system may be negatively impacted when the data processing system is updated using a blueprint that may be defined based on limited knowledge. For example, the blueprint may define a configuration of resources that may be incompatible with other resources, may operate with undesired (e.g., suboptimal) performance, may operate with reduced efficiency (e.g., deploying a quantity of resources higher than necessary for operation of software resulting in underutilization of the resources), and/or any other updates to the data processing system that may negatively impact the quality of computer-implemented services provided by the data processing system.

In general, embodiments disclosed herein may provide methods, systems, and/or devices for managing operation of a deployment comprising data processing systems. To improve a quality of computer-implemented services provided by the data processing systems updated using a blueprint, the blueprint may be modified based on an evaluation using a knowledge base and a trained machine learning model, and with respect to criteria associated with the blueprint.

To do so, management system 102 (e.g., a data processing system tasked with managing other data processing systems) may obtain a prototype blueprint and corresponding criteria. The criteria may indicate, for example, operational (e.g., performance) expectations for any data processing systems that are conformed to the blueprint. Once obtained, the prototype blueprint may be evaluated using a trained machine learning model (e.g., a large language model) and a knowledge base.

The knowledge base may provide information relevant to optimized operation of portions of the blueprint (e.g., resources specified by the blueprint). For example, the knowledge base may include information that indicates performance standards for the portions of the blueprint, compliance regulations, networking rules, security constraints, compatibility between versions of hardware and software, sizing guidelines for instances of computational resources, cost optimization recommendations, and/or any other information.

Using at least the knowledge base and the criteria, the large language model may be prompted to identify at least one potential change to the prototype blueprint. By doing so, a blueprint may be obtained based on the at least one potential change to the prototype blueprint. For example, an order of resources provisioning instructions may be modified based on the identified change, a version and/or type of software may be updated, a size of a storage and/or computational resources may be adjusted, and/or any other potential changes may be applied to the prototype blueprint to obtain the blueprint. The blueprint may be stored in a finalized blueprint repository for subsequent use in updating operation of any number of data processing systems 100.

While operating, the operation of the updated data processing system may be monitored based on the criteria associated with the blueprint. For example, operational data (e.g., telemetry data) may be collected and compared to the criteria. In a first instance of the monitoring where the operation does not meet the criteria, changes may iteratively be made to the blueprint until corresponding operation of the updated data processing system meets the criteria to obtain a finalized blueprint. The finalized blueprint may be stored in finalized blueprint repository.

Additionally, the knowledge base may be updated based on the iteratively made changes to the blueprint. The updates to the knowledge base may be identified based on deviations between operation of a portion of the data processing systems using the blueprints and a portion of criteria corresponding to the blueprints. For example, effects on performance (e.g., a first processing speed is observed when a first change is made to a portion of the blueprint, a second processing speed is observed when a second change is made to the portion of the blueprint, etc.) of a certain configuration of resources defined by the blueprint may be updated and/or added to the knowledge base.

Furthermore, based on the changes to the knowledge base, finalized blueprints from the finalized blueprint repository may be iteratively evaluated to enforce compliance of the finalized blueprints with the knowledge base. For example, new information from the knowledge base may be applied to the finalized blueprints using the trained machine learning model. By doing so, operation of data processing systems 100 may be updated using finalized blueprints based on a knowledge base that may include a higher quality and/or quantity of information compared to a limited knowledge base.

To provide the above noted functionality, the system may include data processing systems 100, and management system 102. Each of these components is discussed below.

Data processing systems 100 may include any number of data processing systems (e.g., 100A-100N) that may provide at least a portion of the computer-implemented services (e.g., to users of data processing system 100). To do so, a data processing system (e.g., 100A) data processing systems 100 may host an automation framework adapted to update operation of the data processing system using a blueprint and use the automation framework to update operation of the data processing system as updated blueprints from management system 102 are provided and/or implemented for the data processing system.

As discussed above, management system 102 may provide management services (e.g., for data processing systems 100). To provide the management services, management system 102 may (i) obtain blueprints (e.g., by providing an interface to obtain the blueprint from a user of management system 102), (ii) obtain criteria associated with the blueprints, (iii) manage a knowledge base relevant to the blueprints, (iv) evaluate a blueprint using a trained machine learning model and the knowledge base to identify potential changes to the blueprint, (v) monitor operation of data processing systems 100 based on the criteria, (vi) iteratively make changes to the blueprint using the machine learning model and the knowledge base, and/or perform any other actions.

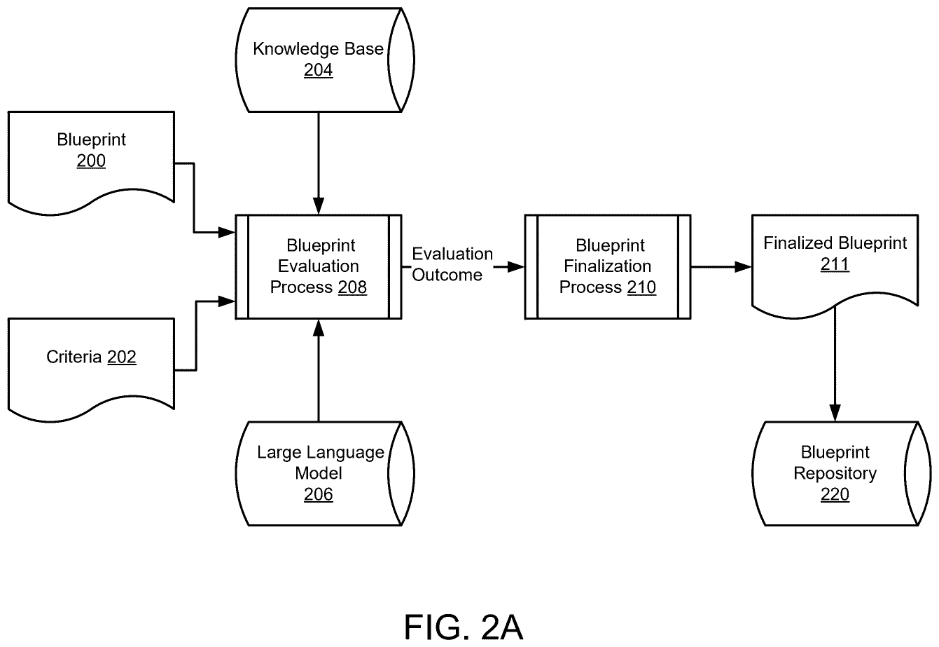

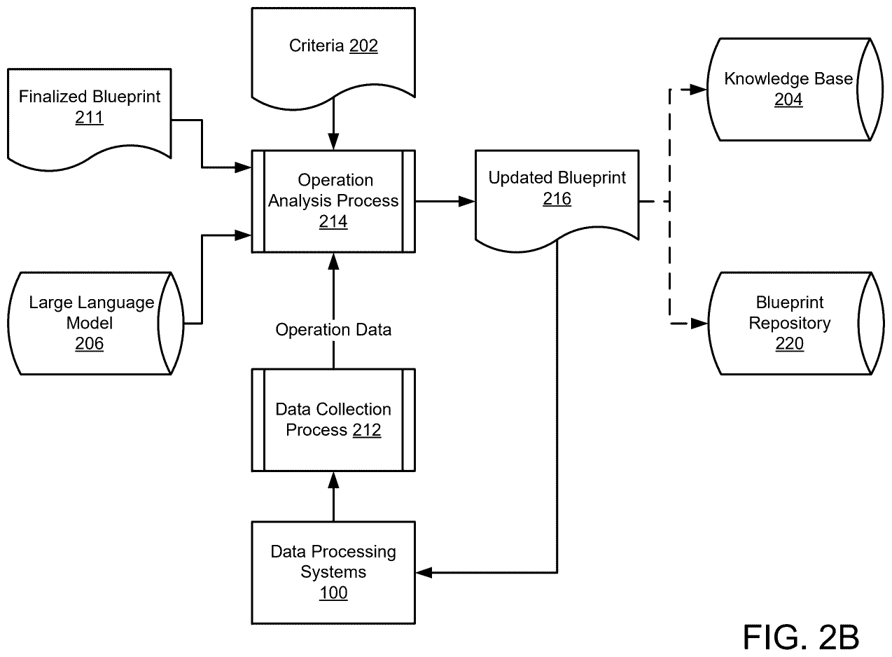

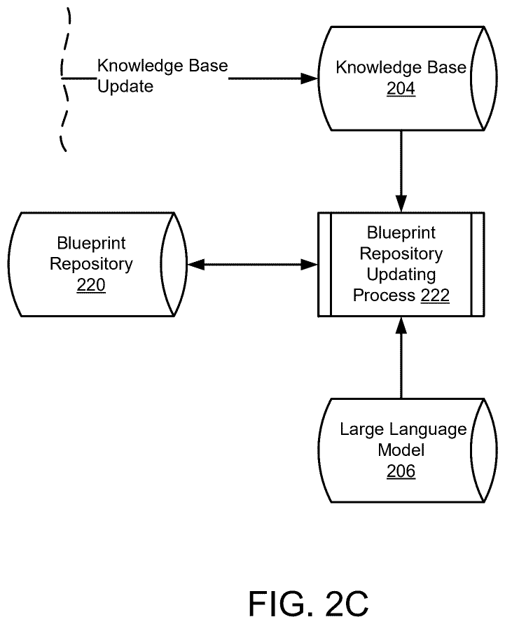

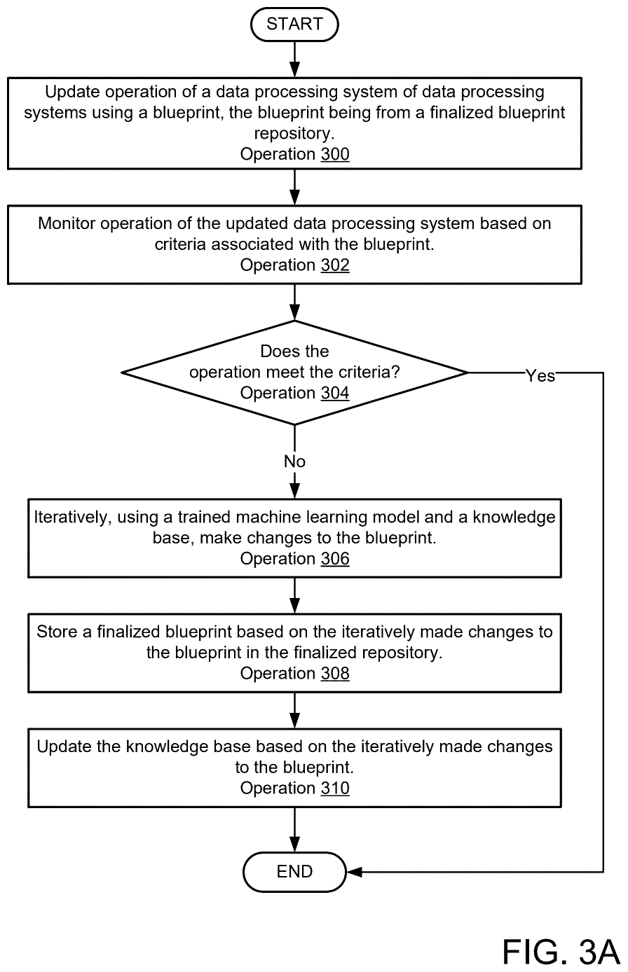

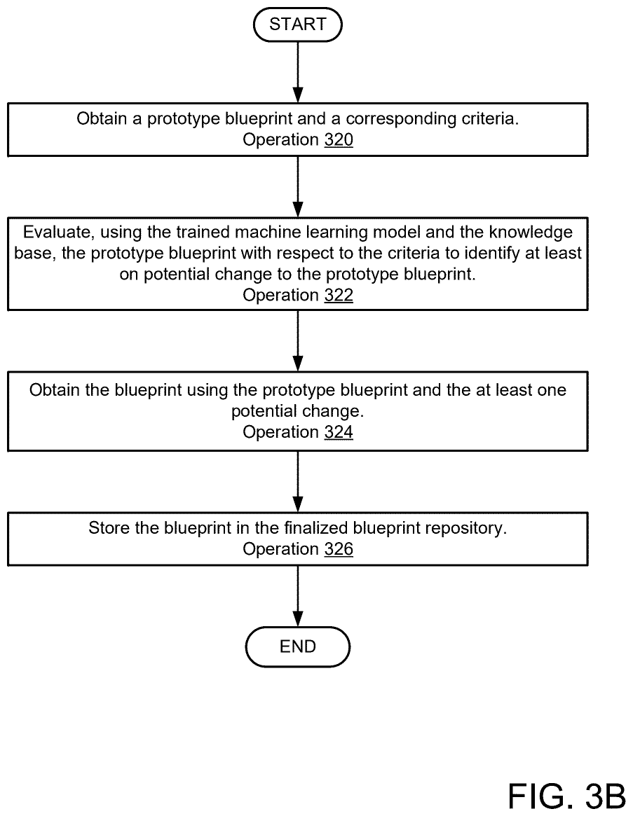

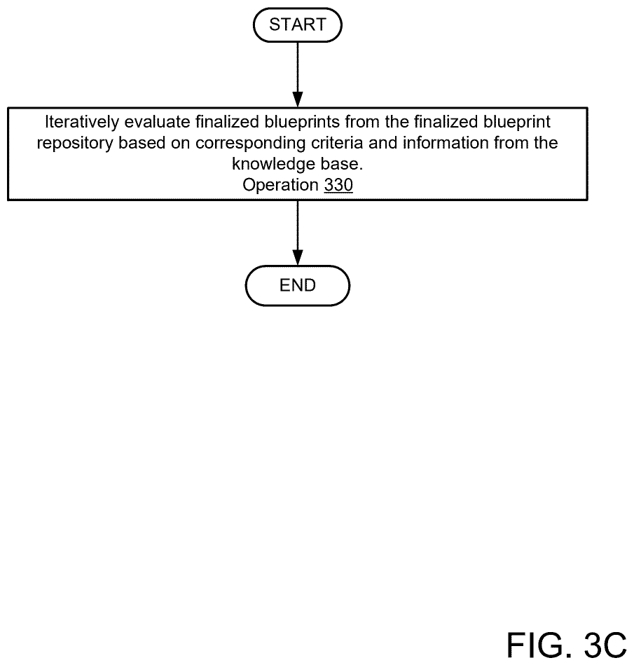

While providing their functionality, any of data processing systems 100 and/or management system 102 may provide all or a portion of the methods shown in FIGS. 2A-3C.

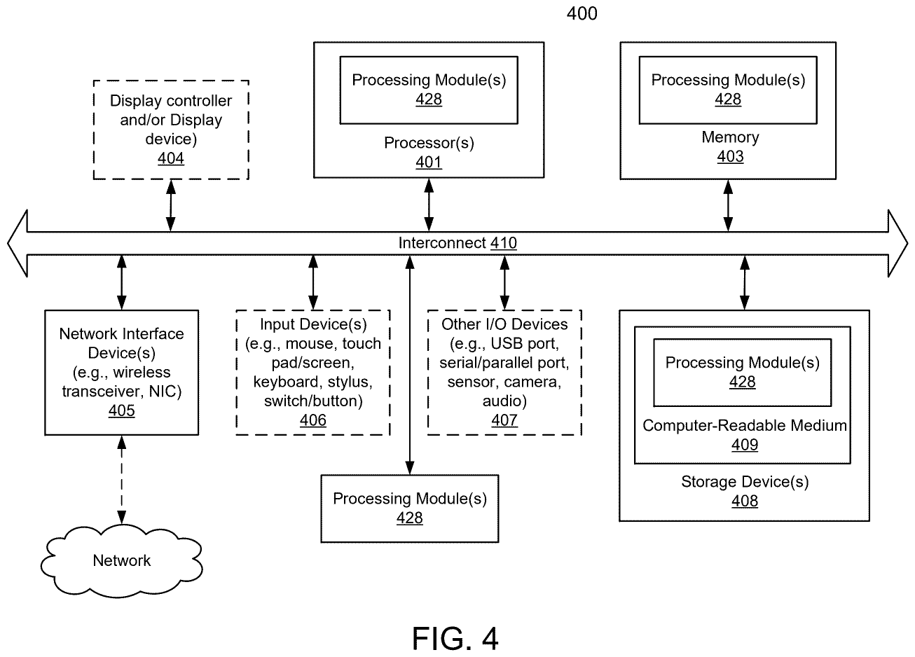

Communication system 104 may allow any of data processing systems 100, and management system 102 to communicate with one another (and/or with other devices not illustrated in FIG. 1). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage operation of a deployment comprising data processing systems that may be configured using blueprints. The blueprints may be iteratively updated based on information provided by a knowledge base and a trained machine learning model managed by a management system. By doing so, a quality of computer-implemented services provided by the data processing systems configured using the updated blueprints may be improved.

While illustrated in FIG. 1 with a limited number of specific components, a system may include additional, fewer, and/or different components without departing from embodiments disclosed herein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 202, etc.) is used to represent data structures, a second set of shapes (e.g., 208, 210, etc.) is used to represent processes performed using and/or that generate data, and a third set of shapes (e.g., 204, 206, etc.) is used to represent large scale data structures such as databases.

Turning to FIG. 2A, a first data flow diagram in accordance with an embodiment is shown. The first data flow diagram may illustrate data used in and data processing performed in obtaining a finalized blueprint based on evaluation of a prototype blueprint.

Blueprint 200 may include any number and/or type of information regarding updating operation of data processing systems 100. For example, blueprint 200 may include instructions for configuring and/or provisioning resources hosted by data processing systems 100 to place data processing systems 100 in a predetermined state. The instructions may include a set of statements (e.g., infrastructure as code) that may be imperative statements (e.g., that define a sequence of tasks to execute to place the data processing system in the predetermined configuration) and/or declarative statements (e.g., that define a desired end state for operation of the data processing system). When executed by data processing systems 100, the instructions specified by blueprint 200 may update the operation of data processing system 100.

Criteria 202 may include any number and/or type of information regarding operational expectations for any of data processing systems 100 that may be conformed to blueprint 200. For example, criteria 202 may include quantitative and/or qualitative information (e.g., metrics, desired outcomes, etc.) that indicates performance expectations, memory requirements, power efficiency, fault tolerance levels, and/or any other conditions defined for desired operation of data processing systems 100. Criteria 202 may be defined for any resources (e.g., hardware, software, etc.) hosted and/or utilized by data processing systems 100 and may be associated with blueprints 200.

Knowledge base 204 may include any number and/or type of information relevant to defining at least a portion of blueprints 200 (e.g., resources specified by a blueprint). For example, the knowledge base may include information that indicates performance standards for the portions of the blueprint, compliance regulations, networking rules, security constraints, compatibility between versions of hardware and software, sizing guidelines for instances of computational resources, cost optimization recommendations, and/or any other information. Knowledge base 204 may be updated based on new information obtained (e.g., via collection of data) regarding operation of data processing systems 100 and/or changes to finalized blueprints (e.g., due to observed deviations between operation of data processing systems based on the finalized blueprints and criteria corresponding to the finalized blueprints).

Large language model 206 may include any number and/or type of information regarding a machine learning model adapted to identify a quality of a blueprint. For example, large language model 206 may include a machine learning architecture (e.g., a neural network framework, an artificial intelligence model, etc.), a set of parameters (e.g., weights, layers, nodes, etc.) to implement a large language model, and/or any other information. Large language model 206 may be prompted to identify and/or generate information relevant to changes for a blueprint based on context provided by management system 102 (e.g., desired outcomes, criteria, a prototype blueprint, telemetry data, etc.).

To obtain the finalized blueprint, blueprint evaluation process 208 may be performed. During blueprint evaluation process 208, a prototype blueprint may be ingested, and the prototype blueprint may be evaluated with respect to criteria. For example, to ingest the prototype blueprint, (i) a user may input a file via a user interface provided by management system 102, (ii) the prototype blueprint may be generated based on second user input that may indicate a desired service to be provided by a portion of data processing systems 100, and/or any other processes may be performed.

Once ingested, blueprint 200 may be evaluated with respect to criteria 202. For example, to evaluate blueprint 200, management system 102 may (i) parse at least a portion of blueprint 200, (ii) prompt large language model 206 to identify deviations between portions of blueprint 200 and information indicated by knowledge base 204, (iii) obtain an inference generated based on at least one potential change (e.g., recommendations for improvement) to the portions of blueprint 200, and/or perform any other actions to obtain an evaluation outcome.

To obtain the finalized blueprint, blueprint finalization process 210 may be performed. During blueprint finalization process 210, an evaluation outcome may be applied to blueprint 200. For example, to apply the evaluation outcome to blueprint 200, (i) the evaluation outcome may be provided to a user (e.g., via a notification), (ii) a user input may be obtained regarding the evaluation outcome with respect to blueprint 200 (e.g., to accept a potential change to apply to blueprint 200), (iii) the evaluation outcome may be automatically applied to blueprint 200 (e.g., based on a configuration of an automation framework hosted by data processing systems 100), and/or any other processes may be performed.

Similar to blueprint 200, finalized blueprint 211 may include information regarding updating operation of data processing systems 100. Finalized blueprint 211 may include any number and/or type of changes made to blueprint 200 based on evaluation using knowledge base 204 and large language model 206. When updated using finalized blueprint 211, data processing systems 100 may provide computer-implemented services that are more likely to meet criteria 202 than data processing systems that may be updated using blueprint 200. Once obtained, finalized blueprint 211 may be stored in blueprint repository 220.

Blueprint repository 220 may host any number and/or type of information regarding blueprints and/or criteria used manage operation of data processing systems 100. Blueprint repository 220 may organize the information, for example, by (i) storing the information in a database with corresponding metadata (e.g., identifiers, tags, etc.), (ii) maintaining the information in a code repository, and/or any other method. Blueprint repository 220 may be updated based on modifications to the blueprints (e.g., as a result of evaluation of the blueprints with respect to criteria and/or operation of data processing systems while using the blueprints).

Thus, using the data flow shown in FIG. 2A, trained local model instances of an inference model may be obtained for each data processing system. By doing so, a set of weights for each trained local model instance may be provided to a management system for use in updating a global model.

Turning to FIG. 2B, a second data flow diagram in accordance with an embodiment is shown. The second data flow diagram may illustrate data used in iteratively updating a blueprint and operation of data processing systems 100 using the blueprint.

To update the blueprint and the operation of data processing systems 100 using the blueprint, data collection process 212 may be performed. During data collection process 212, data relevant to operation of data processing systems 100 may be collected. For example, to collect the data, (i) operation of data processing systems 100 may be monitored (e.g., using software agents hosted by data processing systems 100), (ii) data may be collected using hardware resources (e.g., sensors), (iii) logs may be generated based on activity of data processing systems 100, (iv) data may be stored, at least temporarily, on storage hosted by data processing systems 100, (v) data may be transmitted to management system 102 (e.g., based on a subscription to receive data from data processing systems 100, at configured intervals, etc.), and/or performing any other actions. By doing so, the data may be used in evaluating operation of data processing systems 100 using a blueprint.

To evaluate the operation of data processing systems 100 using a finalized blueprint, operation analysis process 214 may be performed. During operation analysis process 214, operation data may be compared to criteria, and a blueprint used by data processing systems 100 may be updated. For example, to compare the operation data, (i) portions of the operation data may be mapped to corresponding resources defined by finalized blueprint 211, (ii) the operation data may be compared to criteria 202 to identify whether operation of data processing systems 100 meet criteria 202, (iii) large language model 206 may be prompted to identify at least one change to operation of data processing systems 100 and/or finalized blueprint 211, and/or any other processes may be performed to identify the at least one change.

Once identified, the at least one change may be used to update finalized blueprint 211. For example, to update finalized blueprint 211, (i) the at least one change may be provided to a user (e.g., via a notification), (ii) a user input may be obtained regarding the at least one change with respect to finalized blueprint 211 (e.g., to accept the change to apply to finalized blueprint 211), (iii) the at least one change may be automatically applied to finalized blueprint 211 (e.g., based on a configuration of an automation framework hosted by data processing systems 100), and/or any other processes may be performed. By doing so, updated blueprint 216 may be obtained.

Updated blueprint 216 may include any number and/or type of changes made to finalized blueprint 211 based on a result of analysis performed during operation analysis process 214. For example, consider a scenario in which the analysis indicated that a process queue for data processing systems 100 averaged 1000 processes awaiting execution over a one-minute period. Because criteria 202 may indicate a desire to maintain a process queue that does not exceed an average of 700 processes in a one-minute period, updated blueprint 216 may include a change to increase a quantity of computational resources (e.g., central processing unit cores, memory, etc.), add load balancing resources, and/or any other changes identified by large language model 206 based on criteria 202.

Updated blueprint 216 may subsequently be used to update data processing systems 100. For example, management system 102 may deploy instructions indicated by updated blueprint 216 to update operation of data processing systems 100, as shown in FIG. 2B. As discussed above, changes may be iteratively made to the blueprint corresponding to data processing systems 100 (e.g., until operation of data processing systems 100 meets criteria 202). For example, data collection process 212 and operation analysis process 214 may be repeated to update operation of data processing systems 100 until the operation meets criteria 202 based on monitoring of the operation of data processing systems 100.

In an instance of the monitoring where the operation meets criteria 202, updated blueprint 216 (e.g., a version of the blueprint with the most recent changes) may be stored in blueprint repository 220 (e.g., data flow shown in long-dashed lines). By doing so, updated blueprint 216 may be used to update operation of a second portion of data processing systems that may provide similarly desired computer-implemented services.

Additionally, in the instance of the monitoring where the operation meets criteria 202, updated blueprint 216 and/or information associated with updated blueprint 216 (e.g., metadata, relationship information, etc.) may be stored and/or used to update information stored in knowledge base 204 (e.g., data flow shown in long-dashed lines). By doing so, knowledge base 204 may provide more relevant information when used to evaluate and/or update other blueprints (e.g., when used in blueprint evaluation process 208 discussed in FIG. 2A). When updated based on updated blueprint 216, knowledge base 204 may be used to evaluate and/or update at least a portion of blueprint repository 220 to enforce compliance of finalized blueprints with knowledge base 204. Refer to FIG. 2C for additional information regarding enforcing compliance of the finalized blueprints with knowledge base 204.

Thus, using the data flow shown in FIG. 2B, a blueprint used to manage operation of data processing systems may be iteratively updated based on monitoring of the operation with respect to criteria. By doing so, a desirability of computer-implemented services provided by the data processing systems using the blueprint may be improved.

Turning to FIG. 2C, a third data flow diagram in accordance with an embodiment is shown. The third data flow diagram may illustrate data used in and data processing performed in updating a finalized blueprint repository.

As discussed in FIG. 2B, a knowledge base update (e.g., based on an update to a finalized blueprint during monitoring of data processing systems using the finalized blueprint) may update knowledge base 204. When updated, knowledge base 204 may be used to update blueprint repository 220.

To update blueprint repository 220, blueprint repository updating process 222 may be performed. During blueprint repository updating process 222, blueprints stored in blueprint repository 220 may be evaluated, and the blueprints may be updated. For example, to evaluate the blueprints stored in blueprint repository, (i) an analysis service (e.g., software hosted by data processing systems 100 and/or management system 102) may be configured to monitor states of the blueprints, (ii) blueprints may be ingested from blueprint repository 220 and/or processed (e.g., parsed) by management system 102, (iii) large language model 206 may be prompted to identify potential changes to the blueprints based on at least knowledge base 204, and/or any other processes may be performed.

By evaluating blueprint repository 220, finalized blueprints stored in blueprint repository may be updated. For example, the finalized blueprints may be updated by: (i) modifying a configuration of at least a portion of resources defined by the finalized blueprints based on new information, (ii) providing a notification to a user of management system 102 and/or data processing systems 100 regarding an update to the finalized blueprints, (iii) applying a modification to a portion of the finalized blueprints using an automation framework hosted by data processing systems 100, and/or any other processes. By doing so, the finalized blueprints stored in blueprint repository 220 may be updated to be compliant with knowledge base 204 and subsequently be used to update operation of data processing systems 100.

Thus, using the data flow shown in FIG. 2C, finalized blueprints used to manage operation of data processing systems may be iteratively updated based on updates to a knowledge base. By doing so, a quality of computer-implemented services provided by the data processing systems using the finalized blueprints may be improved.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIGS. 3A-3C illustrate methods that may be performed by the components of the system of FIG. 1. In the diagrams discussed below and shown in FIGS. 3A-3C, any of the operations may be repeated, performed in different orders, and/or performed in parallel with or in a partially overlapping in time manner with other operations.

Turning to FIG. 3A, a flow diagram illustrating a method of managing operation of a deployment comprising data processing systems in accordance with an embodiment is shown. The method may be performed, for example, by any of the components of the system of FIG. 1, and/or other components not shown therein.

Prior to operation 300, a blueprint may be stored in a finalized blueprint repository. The blueprint may be stored in a finalized blueprint repository by: (i) obtaining a prototype blueprint and a corresponding criteria, (ii) evaluating the prototype blueprint with respect to the criteria to identify a potential change, (iii) obtaining the blueprint using the prototype and the potential change, (iv) storing the blueprint in the finalize blueprint repository, and/or via any other processes. Refer to FIG. 3B for additional information regarding obtaining the blueprint.

At operation 300, operation of a data processing system of the data processing systems may be updated using a blueprint. The operation may be updated by: (i) executing instructions indicated by the blueprint, (ii) provisioning resources (e.g., software, cloud computing resources, databases, etc.) based on the blueprint, (iii) deploying containerized applications according to the blueprint, (iv) deploying code specified by the blueprint using a pipeline, and/or any via any other processes to obtain an updated data processing system.

At operation 302, operation of the updated data processing system may be monitored based on criteria associated with the blueprint. The operation may be monitored by: (i) configuring a software agent to be host by the data processing system (ii) generating telemetry data during operation of the data processing system, (iii) collecting data using hardware resources (e.g., sensors) hosted by the data processing system, (iv) subscribing to events triggered based on the criteria, (v) generating logs based on activity of data processing systems, and/or performing any other actions.

At operation 304, a determination may be made regarding whether the operation meets the criteria. The determination may be made by: (i) comparing operation data obtained during monitoring of the operation of the data processing system to the criteria, (ii) receiving notification that the operation triggered an event based on the operation data, (iii) converting the operation data to be comparable to the criteria (e.g., unit conversions), and/or any other processes. If the operation meets the criteria does not meet the criteria (e.g., the determination is “No” at operation 304), then the method may proceed to operation 306. If the operation meets the criteria (e.g., the determination is “Yes” at operation 304), then the method may end following operation 304.

At operation 306, changes may iteratively be made to the blueprint until corresponding operation of the updated data processing system meets the criteria. The changes may iteratively be made by: (i) prompting a large language model to identify at least one change to the blueprint based on the criteria, operational data, a knowledge, and/or any other information, (ii) re-deploying the deployment of data processing systems based on a new blueprint updated using the at least one change, (iii) obtaining new data based on the updated data processing systems, and/or via any other processes.

At operation 308, a finalized blueprint may be stored in the finalized blueprint repository. The finalized blueprint may be stored in the finalized blueprint repository by: (i) providing a notification to a management system regarding a change to the finalized blueprint, (ii) overwriting a previous version of the finalized blueprint with the updated blueprint, (iii) adding the finalized blueprint to an active portion of the finalized blueprint repository, and/or performing any other actions.

At operation 310, the knowledge base may be updated based on the iteratively made changes to the blueprint. The knowledge base may be updated by: (i) extracting information relevant to the updated blueprints and operation of data processing systems based on the updated blueprints, (ii) identifying effects corresponding to the changes applied to the blueprints, (iii) adding metadata to resources specified by the blueprints, and/or via any other processes.

The method may end following operation 310.

Using the method shown in FIG. 3A, operation of data processing systems may be managed using a machine learning model and a knowledge base to update blueprints used to update operation of the data processing systems. The updated blueprints may subsequently be more likely to meet criteria associated with respective blueprints.

Turning to FIG. 3B, a second flow diagram illustrating a method of obtaining a blueprint in accordance with an embodiment is shown. The method may be performed, for example, by any of the components of the system of FIG. 1, and/or other components not shown therein.

At operation 320, a prototype blueprint and corresponding criteria may be obtained. The prototype blueprint and corresponding criteria may be obtained by: (i) developing, by a subject matter expert, the prototype blueprint using imperative statements relevant to a predetermined state of the deployment, (ii) obtaining a desired outcome for the deployment with respect to desired computer-implemented services to be provided, (iii) receiving user input regarding the prototype blueprint and the criteria via a user interface (e.g., file upload service), and/or via any other processes.

At operation 322, the prototype blueprint may be evaluated with respect to the criteria to identify at least one potential change. The prototype blueprint may be evaluated by: (i) parsing at least a portion of the prototype blueprint (e.g., into lines of code), (ii) prompting a large language model to identify deviations between portions of the prototype blueprint and information indicated by knowledge base, (iii) obtaining an inference generated based on the at least one potential change (e.g., recommendations for improvement) to the portions of the blueprint, and/or performing any other actions.

At operation 324, the blueprint may be obtained using the protype blueprint and the at least one potential change. The blueprint may be obtained by: (i) providing a notification to a user that a more optimal configuration for the blueprint may have been identified, (ii) receiving user input regarding acceptance or rejection of the at least one potential change, (iii) applying the at least one potential change to the prototype blueprint as a result of an automation framework configured by the data processing systems, and/or via any other processes.

At operation 326, the blueprint may be stored in the finalized blueprint repository. The blueprint may be stored by: (i) writing the blueprint into the finalized blueprint repository, (ii) updating a previous entry of the blueprint stored in the finalized blueprint repository, (iii) assigning the blueprint to a group relevant to a desired operation of the data processing systems, (iv) adding a relationship between the blueprint and corresponding criteria, and/or via any other processes.

The method may end following operation 326.

Using the method shown in FIG. 3B, a blueprint may be obtained by identifying changes (e.g., improvements, optimizations, etc.) to a prototype blueprint defined by a subject matter expert using a large language model and a knowledge base. By doing so, the blueprint may be used to update data processing systems in a manner that is more likely to provide computer-implemented services based on more relevant information provided by the knowledge base.

Turning to FIG. 3C, a third flow diagram illustrating a method of updating finalized blueprints used by the deployment of data processing systems in accordance with an embodiment is shown. The method may be performed, for example, by any of the components of the system of FIG. 1, and/or other components not shown therein.

At operation 330, finalized blueprints from the finalized blueprint repository may iteratively be evaluated based on corresponding criteria and information from the knowledge base. The finalized blueprints may be iteratively evaluated by: (i) triggering an event, based on updates to the knowledge base, to evaluate the finalized blueprint repository, (ii) prompting the large language model to identify changes to resources corresponding to updates to the knowledge base, (iii) applying the changes to the finalized blueprints, (iv) re-deploying the finalized blueprints to update operation of the respective data processing systems, and/or via any other processes.

The method may end following operation 330.

Using the method shown in FIG. 3C, a finalized blueprint repository may be updated based on updates to a knowledge base. By doing so, finalized blueprints stored in the finalized blueprint repository may be enforced to be compliant with the knowledge base.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows®operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment comprising data processing systems, the method comprising:
updating operation of a data processing system of the data processing systems using a blueprint to obtain an updated data processing system, the blueprint being from a finalized blueprint repository;
monitoring operation of the updated data processing system based on criteria associated with the blueprint;
in a first instance of the monitoring where the operation does not meet the criteria:
iteratively, using a trained machine learning model and a knowledge base, making changes to the blueprint until corresponding operation of the updated data processing system meets the criteria;
storing a finalized blueprint based on the iteratively made changes to the blueprint in the finalized blueprint repository; and
updating the knowledge base based on the iteratively made changes to the blueprint.

2. The method of claim 1, wherein the finalized blueprint repository stores finalized blueprints that have been validated against the knowledge base.

3. The method of claim 2, wherein the criteria is obtained from the finalized blueprint repository.

4. The method of claim 3, wherein the criteria and blueprint are defined by a subject matter expert, and the criteria indicates performance expectations for any data processing systems that are conformed to the blueprint.

5. The method of claim 1, wherein the data processing systems host automation frameworks adapted to update operation of the data processing systems using blueprints.

6. The method of claim 5, wherein the blueprints comprise at least one selected from a group consisting of:
imperative statements; and
declarative statements.

7. The method of claim 1, further comprising:
prior to updating the operation of the data processing system:
obtaining a prototype blueprint and a corresponding criteria;
evaluating, using the trained machine learning model and the knowledge base, the prototype blueprint with respect to the criteria to identify at least one potential change to the prototype blueprint;
obtaining the blueprint using the prototype blueprint and the at least one potential change; and
storing the blueprint in the finalized blueprint repository.

8. The method of claim 1, further comprising:
iteratively evaluating finalized blueprints from the finalized blueprint repository based on corresponding criteria and information from the knowledge base to enforce compliance of the finalized blueprints with the knowledge base.

9. The method of claim 8, wherein the finalized blueprints are iteratively evaluated based on changes to the knowledge base.

10. The method of claim 9, wherein the changes to the knowledge base are identified based on corrections to blueprints made based on deviations between operation of some of the data processing systems based on the blueprints and a portion of the criteria corresponding to the blueprints.

11. A non-transitory machine-readable medium having instructions stored therein, which when executed by a processor, cause the processor to perform operations for managing operation of a deployment comprising data processing systems, the operations comprising:
updating operation of a data processing system of the data processing systems using a blueprint to obtain an updated data processing system, the blueprint being from a finalized blueprint repository;
monitoring operation of the updated data processing system based on criteria associated with the blueprint;
in a first instance of the monitoring where the operation does not meet the criteria:
iteratively, using a trained machine learning model and a knowledge base, making changes to the blueprint until corresponding operation of the updated data processing system meets the criteria;
storing a finalized blueprint based on the iteratively made changes to the blueprint in the finalized blueprint repository; and
updating the knowledge base based on the iteratively made changes to the blueprint.

12. The non-transitory machine-readable medium of claim 11, wherein the finalized blueprint repository stores finalized blueprints that have been validated against the knowledge base.

13. The non-transitory machine-readable medium of claim 12, wherein the criteria is obtained from the finalized blueprint repository.

14. The non-transitory machine-readable medium of claim 13, wherein the criteria and blueprint are defined by a subject matter expert, and the criteria indicates performance expectations for any data processing systems that are conformed to the blueprint.

15. The non-transitory machine-readable medium of claim 11, wherein the data processing systems host automation frameworks adapted to update operation of the data processing systems using blueprints.

16. A system, comprising:
a processor; and
a memory coupled to the processor to store instructions, which when executed by the processor, cause the processor to perform operations for managing operation of a deployment comprising data processing systems, the operations comprising:
updating operation of a data processing system of the data processing systems using a blueprint to obtain an updated data processing system, the blueprint being from a finalized blueprint repository;
monitoring operation of the updated data processing system based on criteria associated with the blueprint;
in a first instance of the monitoring where the operation does not meet the criteria:
iteratively, using a trained machine learning model and a knowledge base, making changes to the blueprint until corresponding operation of the updated data processing system meets the criteria;
storing a finalized blueprint based on the iteratively made changes to the blueprint in the finalized blueprint repository; and
updating the knowledge base based on the iteratively made changes to the blueprint.

17. The system of claim 16, wherein the finalized blueprint repository stores finalized blueprints that have been validated against the knowledge base.

18. The system of claim 17, wherein the criteria is obtained from the finalized blueprint repository.

19. The system of claim 18, wherein the criteria and blueprint are defined by a subject matter expert, and the criteria indicates performance expectations for any data processing systems that are conformed to the blueprint.

20. The system of claim 18, wherein the data processing systems host automation frameworks adapted to update operation of the data processing systems using blueprints.
